(19) United States
(12) Patent Application Publication
(10) Pub. No.: US 2025/0224027 A1
(43) Pub. Date: Jul. 10, 2025

(54) VENT ASSEMBLY WITH ALTERNATING MEDIA SECTIONS

(71) Applicant: Donaldson Company, Inc., Bloomington, MN (US)

(72) Inventors: Gregory S. Tronnes, Bloomington, MN (US); Yehya A. Elsayed, Bloomington, MN (US); Vijay K. Kapoor, Eagan, MN (US); Marc J. Andvik, Bloomington, MN (US)

(21) Appl. No.: 19/013,953

(22) Filed: Jan. 8, 2025

Related U.S. Application Data
(60) Provisional application No. 63/619,200, filed on Jan. 9, 2024.

(51) Int. Cl. F16H 57/027

(52) U.S. Cl. CPC F16H 57/027

(57) ABSTRACT

Some embodiments of the present technology relate to a vent assembly. The vent assembly has a vent housing having a first end and a second end. The vent housing defines a mounting structure and an airflow pathway extending from the mounting structure to the environment external to the vent housing. A plurality of sections of filtration media are arranged in a series along the airflow pathway. The plurality of sections are disposed across the airflow pathway. The plurality of sections of filtration media includes efficiency sections and spacer sections alternating with the efficiency sections within the series. Each spacer section has a flow resistivity up to 80% of a flow resistivity of each efficiency section.

This application claims the benefit of U.S. Provisional Application 63/619,200 filed on Jan. 9, 2024, the subject matter of which is incorporated by reference in its entirety.

### TECHNOLOGICAL FIELD

The present disclosure is generally related to vent assembly. More particularly, the present disclosure is related to a vent assembly with alternating media sections.

### BACKGROUND

Various types of gearboxes, such as automotive transmissions, differential cases, and power transfer units, generally require some sort of breather vent that allows the pressure between the gearbox and the external environment to equalize. Some breather vents incorporate filter media to prevent the ingress of contaminants such as dust and fluids to the gearbox. For example, a microporous membrane can be used to prevent the entry of water in the gearbox. Oil particles that are present in the gearbox, however, can become airborne and lodge into the membrane. Oil coalescing filter media can be used to prevent the membrane from being clogged with oil. Some coalescing media uses an oil sorbent (e.g., absorbent and/or adsorbent of oil) filter media that is configured to capture the oil particles or vapor before they reach the membrane. However, such vents have a relatively short lifespan because, as the oil particles accumulate in the media, the media becomes clogged, which decreases the life of the vent. Furthermore, because the sorbent filter media wicks the oil particles, the oil can foul the membrane relatively quickly.

### SUMMARY

Some embodiments of the technology disclosed herein relate to a vent assembly. A vent housing has a first end and a second end. The vent housing defines a mounting structure and an airflow pathway extending from the mounting structure to the environment external to the vent housing. A plurality of sections of filtration media are arranged in a series along the airflow pathway. The plurality of sections are disposed across the airflow pathway. The plurality of sections of filtration media includes efficiency sections and spacer sections alternating with the efficiency sections within the series. Each spacer section has a flow resistivity up to 80% of a flow resistivity of each efficiency section.

In some such embodiments, the plurality of sections includes at least five sections. Additionally or alternatively, the vent assembly includes at least 7 sections per 100 mm of series thickness. Additionally or alternatively, each efficiency section has a flow resistivity from 25.5 Pa/(cm/s)/cm to 125 Pa/(cm/s)/cm. Additionally or alternatively, each spacer section has a flow resistivity up to 23.6 Pa/(cm/s)/cm. Additionally or alternatively, the efficiency sections have a combined thickness of 70%-95% of the total thickness of the series at 10.34 kPa. Additionally or alternatively, the series has an overall particle capture efficiency of at least 97%. Additionally or alternatively, each efficiency section has a particle capture efficiency of greater than 75%. Additionally or alternatively, each section has a density from 0.10 to 0.4 g/cm³ at 10.34 kPa. Additionally or alternatively, the plurality of sections includes binder fibers and glass fibers. Additionally or alternatively, the vent assembly has a membrane disposed in the vent housing across the airflow pathway between the plurality of sections and the external environment. Additionally or alternatively, the vent assembly has an adsorbent layer disposed across the airflow pathway between the membrane and the plurality of sections. Additionally or alternatively, at least one spacer layer includes an adsorbent. Additionally or alternatively, each spacer section has a Frazier air permeability of at least 200 ft³/min/ft².

Some embodiments of the technology disclosed herein relate to a vent assembly having a vent housing having a first end and a second end. The vent housing defines a mounting structure and an airflow pathway extending from the mounting structure to the environment external to the vent housing. A plurality of sections of filtration media are arranged in a series along the airflow pathway. The plurality of sections are disposed across the airflow pathway. The plurality of sections of filtration media includes efficiency sections and spacer sections alternating with the efficiency sections within the series. The series has an overall particle capture efficiency of at least 97%. Each efficiency section has a particle capture efficiency of at least 80%.

In some such embodiments, the plurality of sections includes at least five sections. Additionally or alternatively, the vent assembly includes at least 7 sections per 100 mm of series thickness. Additionally or alternatively, each efficiency section has a flow resistivity from 25.5 Pa/(cm/s)/cm to 125 Pa/(cm/s)/cm. Additionally or alternatively, each spacer section has a flow resistivity up to 23.6 Pa/(cm/s)/cm. Additionally or alternatively, the efficiency sections have a combined thickness of 70%-95% of the total thickness of the series at 10.34 kPa. Additionally or alternatively, each spacer section has a flow resistivity up to 80% of a flow resistivity of each efficiency section. Additionally or alternatively, each efficiency section has a particle capture efficiency of at least 85%. Additionally or alternatively, each section has a density from 0.10 to 0.4 g/cm³ at 10.34 kPa. Additionally or alternatively, the plurality of sections includes binder fibers and glass fibers. Additionally or alternatively, a membrane is disposed in the vent housing across the airflow pathway between the plurality of sections and the external environment. Additionally or alternatively, an adsorbent layer is disposed across the airflow pathway between the membrane and the plurality of sections. Additionally or alternatively, at least one spacer layer includes an adsorbent. Additionally or alternatively, each spacer section has a Frazier air permeability of at least 200 ft³/min/ft².

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

FIG. 1 is a perspective view of an example filter assembly consistent with the present disclosure.

FIG. 2 is an example cross-sectional view consistent with the example filter assembly of FIG. 1.

FIG. 3 is a graph depicting test results of an example vent assembly configuration.

FIG. 4 is a graph depicting test results of an example vent assembly configuration consistent with the present disclosure.

FIG. 5 is a graph depicting test results of yet another example vent assembly configuration consistent with the present disclosure.

FIG. 6 is a graph depicting comparative test results of vent assemblies.

FIG. 7 is a graph depicting further comparative test results of vent assemblies.

FIG. 8 is another graph depicting further comparative test results of vent assemblies.

FIG. 9 is another graph depicting further comparative test results of vent assemblies.

FIG. 10 is a schematic of an example test configuration.

FIG. 11 is a graph showing pressure differential over time for example vent assemblies tested in accordance with the description of FIG. 10.

FIG. 12 is a graph showing pressure differential over time for example vent assemblies.

FIG. 13 is a schematic of an example test configuration used to collect the data reflected in FIG. 12.

FIG. 14 is an example flow chart depicting a method consistent with the present disclosure.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

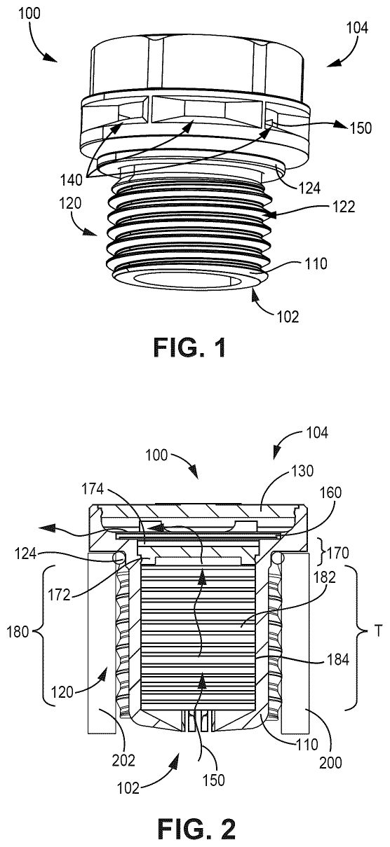

FIG. 1 is a perspective view of a vent assembly 100 consistent with the technology disclosed herein, and FIG. 2 is a cross-sectional view of the vent assembly 100 of FIG. 1. The vent assembly 100 generally has a vent housing 110 defining a first end 102, a second end 104, a mounting structure 120, and an airflow pathway 150 extending from the mounting structure 120 to the environment external to the vent housing 110. The vent assembly 100 generally has a plurality of sections of filtration media 180 disposed in the vent housing 110.

The vent assembly 100 is generally configured to vent an enclosure 200 (such as that depicted in FIG. 2) to which it is mounted while preventing the entry of dust, fluids, and other contaminants to the enclosure 200. In embodiments, the vent assembly 100 is designed to achieve IP69K ingress protection, meaning that, upon installation, the vent assembly 100 protects the enclosure 200 against close-range, high-pressure, high-temperature spray-downs. In embodiments, the vent assembly 100 is configured to meet a different industry standard for ingress protection. The vent assembly 100 is also configured to prevent the passage of oil aerosols from the enclosure 200 to the second end 104 of the vent assembly 100.

The vent housing 110 is generally configured define an airflow pathway between the enclosure 200 to which the vent housing 110 is coupled and the external environment to eliminate or reduce the pressure differential between the enclosure 200 and the external environment. The vent housing 110 may be any suitable material including plastic or metal. In some embodiments, the vent housing 110 can be constructed of one or more materials including nylon, polyamide, glass-filled polyamide, polybutylene terephthalate, glass-filled polybutylene terephthalate, high-density polyethylene, and/or polypropylene, as examples.

In various implementations, the enclosure 200 (that the vent housing 110 is configured to be coupled to) is generally configured to contain oil. The enclosure 200 can also be configured to contain moving parts, such as gears. The enclosure 200 can be used for a variety of applications such as, for example, transmission systems, transfer cases, gear boxes, power transfer units, axle components, and the like. Such applications can particularly be found within industries such as automotive, manufacturing, energy production, and the like. Those having skill in the art will appreciate the wide applicability of the current technology to a variety of technological fields.

The vent housing 110 defines a mounting structure 120 that is configured to couple to the enclosure 200. The mounting structure 120 is defined towards the first end 102 of the vent housing 110. In the current example the mounting structure 120 defines a circumferential threading 122 that is configured to engage the enclosure 200 itself, such via mating threading defined by the enclosure 200. Alternatively, the mounting structure 120 can be configured to engage an intermediate component that is configured to couple the vent housing 110 and the enclosure 200. Other approaches can be used to couple the vent assembly 100 directly or indirectly to the enclosure 200, as will be appreciated. The mounting structure 120 can have alternative configurations to sealably couple to the enclosure 200. In some embodiments, the mounting structure 120 is a snap fit, hose barb, bead interface, bayonet connector, fastener openings each configured to receive a fastener, or a surface that is configured to adhere to the enclosure itself (or an intermediate component that couples to the enclosure) such as via an adhesive or a weld, as examples.

In various embodiments, the mounting structure 120 includes an o-ring or gasket 124 (best visible in FIG. 2) to sealably couple the vent assembly 100 to the enclosure 200. The o-ring is configured to be positioned between the mounting structure 120 and the enclosure 200 about an opening 202 in the enclosure 200. In some embodiments, the o-ring contacts the enclosure 200 and the mounting structure 120 to form an airtight seal. In some embodiments a mounting structure 120 of a vent assembly 100 can be configured to directly receive the opening 202 defined by the enclosure 200. In some embodiments, the o-ring 124 can be configured to be compressibly and sealably disposed between the mounting structure 120 and the enclosure 200.

From the mounting structure 120, the airflow pathway 150 extends through the plurality of sections of filtration media 180 to the external environment. The vent housing 110 defines perimeter openings 140 such that the airflow pathway 150 extends to the external environment through the perimeter openings 140. The vent assembly 100 has a vent cap 130 that is coupled to the vent housing 110.

The plurality of sections of filtration media 180 are disposed in the vent housing 110 across the airflow pathway 150. The plurality of sections of filtration media 180 are generally configured to capture oil aerosols to prevent the passage of oil aerosols. The plurality of sections of filtration media 180 will be discussed in more detail below.

### Membrane

In some embodiments, a membrane 160 is coupled to the vent housing 110 across the airflow pathway 150. It is noted that various embodiments can omit the membrane 160, however. Where a membrane 160 is included, the membrane 160 is generally configured to serve as a barrier to outside fluid and dust contamination for the enclosure 200 while allowing air exchange between the enclosure 200 and the environment external to the enclosure 200 (such as the atmosphere). In a variety of embodiments, the membrane 160 is coupled to a membrane receiving surface 112 defined by the vent housing 110. In one example, the membrane 160 is pleated to increase airflow.

The membrane 160 is positioned towards the second end 104 and the plurality of sections of filtration media 180 is positioned towards the first end 102. The membrane 160 is positioned between the external environment and the plurality of sections of filtration media 180 along the airflow pathway 150.

Various types of materials would be suitable for use as the membrane 160. Generally, the membrane 160 is a microporous material, where the term “microporous” is intended to mean that the material defines pores having an average pore diameter between about 0.001 and about 5.0 microns. The membrane 160 generally has a solidity of less than about 50% and a porosity of greater than about 50%. In a variety of embodiments, the membrane 160 has a plurality of nodes interconnected by fibrils. In a number of embodiments the membrane 160 is an expanded polytetrafluoroethylene (ePTFE) membrane. The membrane 160 can also be constructed of polyamide, polyethylene terephthalate, acrylic, polyethersulfone, and/or polyethylene, as other examples. The membrane 160 can have a water entry pressure (WEP) of at least 5 psi.

In some embodiments the membrane 160 is a laminate. For example, the membrane 160 can be a Tetratex™ laminate grade from Donaldson Company, Inc., based in Minneapolis, MN.

In a number of embodiments the membrane 160 is oleophobic. The membrane 160 can have an oleophobic treatment. In one particular embodiment the membrane 160 has an oleophobicity rating of 6, 7 or 8 based on AATCC Specification 118-1992 and ISO 14419. It is noted that various embodiments can omit the membrane 160, however.

### Spacing Region

In the current example, the vent assembly 100 has a spacing region 170 defined by the vent assembly 100 between the plurality of sections of filtration media 180 and the membrane 160. The spacing region 170 of the vent assembly 100 is generally configured to prevent contact between oil from the enclosure 200 and the membrane 160. In particular, the spacing region 170 can be configured to impede wicking of the oil towards the membrane 160. The spacing region 170 can also be configured to prevent contact between the plurality of sections of filtration media 180 and the membrane 160. The spacing region 170 can be a physical barrier between the plurality of sections of filtration media 180 and the membrane 160. In at least one example, the spacing region 170 can be a physical barrier that is configured to contain the plurality of sections of filtration media within the vent housing 110.

In a variety of embodiments, including that depicted in FIG. 2, the spacing region 170 is at least partially defined by a media spacer 172. The media spacer 172 is disposed within the vent housing 110 between the plurality of sections of filtration media 180 and the membrane 160. The spacing region 170 is also defined by a physical gap 174 between the media spacer 172 and the membrane 160. In an alternate embodiment, the spacing region 170 lacks a media spacer and is merely a physical gap between the plurality of sections of filtration media and the membrane.

### Plurality of Sections of Filtration Media

The plurality of sections of filtration media 180 is generally configured to capture oil aerosol as it passes through the vent assembly 100 via the airflow pathway 150 from the enclosure 200. Such a configuration may advantageously prevent such oil from being deposited on the membrane 160 (where a membrane 160 is present), which can result in pore blockages in the membrane 160, resulting in reduced vent life. The plurality of sections of filtration media 180 are also configured to retain captured oil aerosol while maintaining breathability of the plurality of sections of filtration media 180 for its useful life. In various embodiments, the plurality of sections of filtration media 180 are designed to maximize the amount of oil aerosol that can be captured, thereby providing a relative increase in the useful life of the plurality of sections of filtration media 180.

### Configuration

The plurality of sections of filtration media 180 are generally arranged in a series along the airflow pathway 150, such as in a stacked configuration, meaning that airflow along the airflow pathway 150 is configured to pass through each of the sections of filtration media 180 consecutively. In various embodiments, the plurality of sections of filtration media 180 include efficiency sections 182 and spacer sections 184. Efficiency sections 182 are generally configured to capture and store oil aerosols, and spacer sections 184 are configured to define space between the efficiency sections 182. The spacer sections 184 are generally configured such that they do not capture and store oil aerosols. In various examples, the spacer sections 184 are configured to interrupt the flow of captured oil from a first efficiency section 182 on one side of the spacer section 184 to a second efficiency section 182 on the opposite side of the spacer section 184.

The efficiency sections 182 generally alternate with the spacer sections 184 in the series. In some embodiments the efficiency sections 182 regularly alternate with the spacer sections 184 in the series in a predictable pattern. In other embodiments the alternating between the efficiency sections 182 and spacer sections 184 is irregular. For example, the thickness of one or more efficiency sections 182 can be unequal to the thickness of one or more other efficiency sections 182, or the thickness of one or more spacer sections 184 can be unequal to the thickness of one or more other spacer sections 184. In various embodiments, two efficiency sections 182 abut each spacer section 184 on opposite sides of the spacer section 184. In some other embodiments, one or more additional intervening sections can be disposed between an efficiency section 182 and a spacer section 184.

In some embodiments, the vent assembly 100 has at least 7, 9, or 10 sections per 100 mm of total series thickness T, where the “series thickness” is the total distance across all of the plurality of sections of filtration media 180. In some embodiments, the vent assembly 100 has at least 20, 30, or 40 sections per 100 mm of total series thickness T. It is noted that, in embodiments where the efficiency sections 182 and spacer sections 184 are arranged in a stack, the total series thickness is the height of the stack. In one example implementation of the current technology, the total series thickness Tis 11 mm to 15 mm, 12 mm to 13 mm, or about 12.5 mm. However, other series thicknesses Tare also contemplated, such as 20 mm to 80 mm, 50 mm to 100 mm, or 75 mm to 125 mm.

The efficiency sections 182 can be differentiated from the spacer sections 184 by at least flow resistivity. “Flow resistivity” as used herein characterizes the resistance to airflow of a material per unit thickness of the material at 1 cm/s air velocity at atmospheric temperature and pressure. Generally, the efficiency sections 182 have a flow resistivity that is higher than the flow resistivity of the spacer sections 184. where each spacer section 184 has a flow resistivity that is up to 80% of the flow resistivity of each efficiency section 182. Each efficiency section 182 (and, indeed, all of the efficiency sections) can have a flow resistivity greater than 24.0, 24.5 or 25.0 Pa/(cm/s)/cm. Each efficiency section 182 can have a flow resistivity less than 95, 90, or 89 Pa/(cm/s)/cm, in some embodiments. However, the maximum flow resistivity of the efficiency sections is not particularly limited and can be based on the operating conditions and/or desired performance of the vent assembly 100. In some embodiments each efficiency section 182 ranges from 25.5 Pa/(cm/s)/cm to 88.6 Pa/(cm/s)/cm. Each spacer section 184 (and, indeed, all of the spacer sections) can have a flow resistivity of less than 26, 25, or 24 Pa/(cm/s)/cm. The lower limit of the flow resistivity of the spacer section 184 is not particularly limited. In some particular example vent assemblies tested, the flow resistivity of the spacer section 184 is greater than 9, 10, or 11 Pa/(cm/s)/cm. In various embodiments the flow resistivity of the spacer section ranges from 11.8 Pa/(cm/s)/cm to 23.6 Pa/(cm/s)/cm.

The efficiency sections 182 and spacer sections 184 can have a variety of different configurations and combinations of configurations. In some embodiments, one or more of the plurality of sections of filtration media 180 is one or more layers of filter material arranged in a series (such as in a stacked configuration). In some embodiments, each of the plurality of sections of filtration media 180 is one or more layers of filter material arranged in a series. The layers can be unbonded in various embodiments, although in some other embodiments the layers can be bonded. In some embodiments, one or more of the plurality of sections of filtration media 180 is a mass of fibers. In some embodiments, at least one of the plurality of sections of filtration media 180 includes an adsorbent, where “adsorbent” is used herein to refer to, for example, activated carbon, silica gel, molecular sieves, and the like.

In various embodiments, each efficiency section 182 has a higher particle capture efficiency than each spacer section 184. In some embodiments, each efficiency section has a particle capture efficiency of greater than 70%, 75% or 80%, where particle capture efficiency is assessed with a High-Efficiency Flat Sheet (HEFS) TSI Automated Filter Tester, Model 8127, test bench (TSI Incorporated, Shoreview, MN) to measure particle capture efficiency using 0.3 μm oil (bis(2-ethylhexyl) sebacate, Sigma-Aldrich) droplets (aerosol) at a flow rate of 14.7 liters per minute (L/min) to challenge 4-inch diameter or larger media samples. This bench was used to test up to 4 layers of media at a time. TSI's CertiTest Model 8127 Automated Filter Tester is designed for testing filters, respirator cartridges, and filter media to the latest American government and industry-wide specification and meets the standards of 42 CFR § 84 (Jun. 8, 1995).

The penetration is calculated, which is the ratio of the measured number of 0.3 μm particles downstream of the sample and the measured number of 0.3 μm particles upstream of the sample. After the single layer penetration was calculated, the total penetration value was calculated using the following formula below. The number of layers could then be adjusted to reach the target penetration.

Penetrationₜₒₜₐₗ=(Penetration_{single layer})ⁿ

where n is the number of layers of media, Penetrationₜₒₜₐₗ is for a stack of layers, and Penetration_{single layer} is the penetration of one layer, where a layer can be a single section of filtration media, multiple sections of filtration media, or a portion of a section of filtration media. The particle capture efficiency, whether for the total number of layers or for a single layer, is the percentage of particles that did not penetrate the media, or 100−Penetration*100. In various embodiments, the spacer sections exhibit too low of a particle capture efficiency to be assessed by the HEFS TSI Automated Filter Tester test bench without a relatively high degree of uncertainty.

In various embodiments, each efficiency section 182 has a higher density than each spacer section 184. In some embodiments the density of each efficiency section 182 is less than or equal to the density of each spacer section 184. In some embodiments, the surface area per unit volume of each efficiency section 182 is greater than the surface area per unit volume of each spacer section 184. In some embodiments, each efficiency section 182 has a lower Frazier air permeability than each spacer section 184. In some embodiments, each spacer section has a Frazier air permeability ranging from 200 ft³/min/ft² to 450 ft³/min/ft² or 213 ft³/min/ft² to 425 ft³/min/ft². In some embodiments, each efficiency section has a Frazier air permeability ranging from 8 ft³/min/ft² to 17 ft³/min/ft² or 9.5 ft³/min/ft² to 15 ft³/min/ft². In some embodiments, each efficiency section has a Frazier air permeability of no more than 20, 30, or 40 ft³/min/ft².

In some embodiments, each efficiency section 182 has a higher clean pressure drop than each spacer section 184, where clean pressure drop is defined as the difference in pressure across the section of filtration media prior to particle capture by the particular section of filtration media. Clean pressure drop (dP) was calculated based on known variables of the material including flow resistivity, thickness of the material at 1.5 psi (10.34 kPa), and a flow velocity of 9.1 cm/s. In some embodiments, each efficiency section has a clean pressure drop ranging from 130 Pa to 250 Pa or 150 Pa to 235 Pa. In some embodiments, each spacer section has a clean pressure drop ranging from 2 Pa to 13 Pa or 4 Pa to 11 Pa.

Generally, the plurality of sections of filtration media 180 is configured to capture oil aerosols and therefore has a relatively high particle capture efficiency to allow such functionality. The plurality of sections of filtration media 180 can have an overall particle capture efficiency of at least 90%, at least 95%, and/or at least 99%, wherein “overall particle capture efficiency” is used herein to refer to the percentage of particles that do not penetrate through the plurality of sections of filtration media 180 using the HEFS TSI Automated Filter Tester, Model 8127 test bench discussed above with corresponding calculations. This calculation ignores any contribution to efficiency of the spacer sections.

The plurality of sections of filtration media 180 can have a clean pressure drop of less than 1.2 psi, 1.0 psi, or even 0.8 psi.

As is described in more detail below, it has been discovered that alternating spacer sections with efficiency sections increases the volume of oil that can be contained by the efficiency sections.

### Test Results

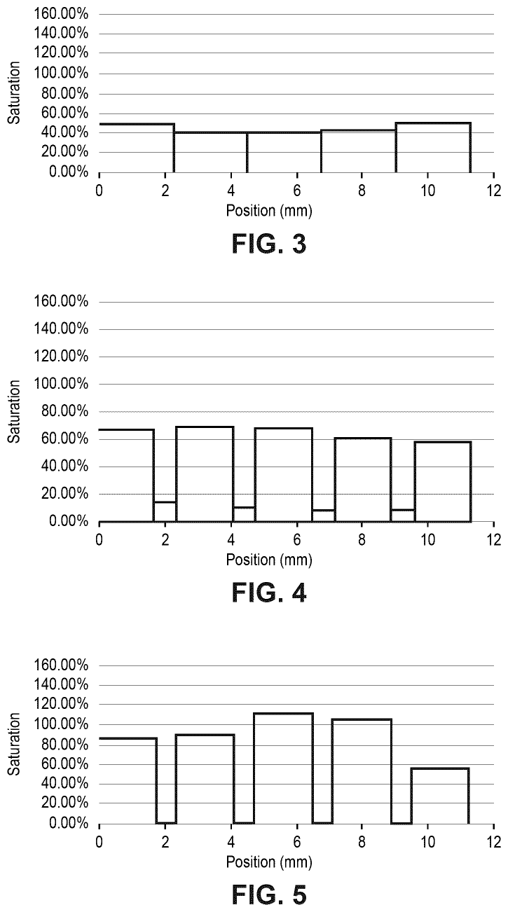

FIGS. 3-5 are test results reflecting the saturation of oil in each of a plurality of sections of filtration media by volume, where vent assemblies generally consistent with FIGS. 1-2 were tested, with differences between the tested vent assemblies and the vent assemblies of FIGS. 1-2 noted herein. The housing of each of the vent assemblies was a stainless steel syringe filter housing. As such, unlike the vent assemblies of FIGS. 1-2, the syringe filter housing has an upstream and downstream side, with an inlet on the upstream side and an outlet on the downstream side. The outlet is vented to the atmosphere. The syringe filter housing has an inside depth from top to bottom of 19.33 mm. The syringe filter housing contained the following between the inlet to the outlet, from upstream to downstream: (1) two buna rubber washers; (2) a plurality of sections of filtration media that was nominally 16.5 mm thick when measured using 10.34 kPa of pressure; (3) one buna rubber washer; and one membrane layer.

Compressed air, pressurized at 6.9 bar, was supplied to a Topas ATM220 Aerosol Generator (Topas GmbH based in Germany) filled with off the shelf automatic transmission fluid. The pressure was reduced using the integrated pressure regulator to 400 mbar, which created a constant flow rate of aerosol. This flow was directed into an aerosol source chamber with a first port and a second port. The first port was attached to the inlet of the syringe filter housing. A pressure manometer was coupled to the second port to measure the pressure differential relative to ambient pressure. The pressure was sampled every 10 seconds. All tests were run at ambient conditions at the constant flow rate until a terminal pressure drop of 140 mbar was reached.

To evaluate the response of the vent to oil loading, the inlet of the vent assembly was coupled to the aerosol source chamber and the manometer's auto-logging feature was used to sense and record pressure. The next step was to turn the compressed air supply to the aerosol generator. The bench was monitored to confirm proper operation until the terminal pressure drop. The vent assembly was then removed from the bench and the final weight of the individual sections were measured.

To calculate the saturation of the media, first the porosity (void volume) was determined using the mass method. To do this the weight, area and thickness at 10.34 kPa of each section of filtration media was measured. Porosity was then calculated using the following equation:

$$ε = 1 - \frac{M}{ρ V}$$

where ε is the porosity (void volume), M is the mass of the section, p is the average density of the fibers in the section, and V is the total volume of the section. The plurality of sections of filtration media were then inserted into the filter holder and loaded with oil until the terminal pressure drop had been reached using the equipment listed above. The plurality of sections of filtration media were then removed from the syringe filter holder and the individual sections were weighed again. The difference in weight was the increase in oil and this value was divided by the density of the oil used of 0.83 g/cm³ to get the total oil volume. The oil volume was divided by the initial media porosity (void volume) to get the saturation percentage at the terminal pressure drop.

FIG. 3 is test data reflecting the saturation of oil in each of a plurality of efficiency sections by volume, where a vent assembly consistent with FIGS. 1-2 has a stack of efficiency sections arranged across the airflow pathway of the vent body. The efficiency sections are arranged in series along the airflow pathway of the vent body. Each efficiency section is identical and has a plurality (in particular, 11) of discrete and identical layers of filter material. Each layer has a thickness of 0.3 mm at 10.34 kPa. No spacer sections were used between efficiency sections, so that the plurality of sections of filtration media is entirely efficiency sections. The x-axis reflects the position along the series thickness of each efficiency section, where the “0 mm” position is the surface of the efficiency section closest to the first end of the vent body. The y-axis reflects the percent saturation of the efficiency section with oil in terms of the available volume defined by the efficiency section. In the example test, the efficiency section has a flow resistivity of 57.0 Pa/(cm/s)/cm.

As is visible in FIG. 3, the first efficiency section and the last efficiency section had the highest saturation with oil, which was just under 50% of the volume of the efficiency section. The intermediate efficiency sections contained around 40% of oil by volume of the efficiency section.

FIG. 4 shows comparison data of a vent assembly consistent with the technology disclosed herein. More particularly, efficiency sections alternate with spacer sections in a series along the airflow pathway of a vent body consistent with descriptions above. Each of the efficiency sections and spacer sections extend across the airflow pathway. The efficiency sections are identical to those described above with respect to FIG. 3, except that each efficiency section has 9 discrete and identical layers of efficiency filter material. The spacer sections are disposed between each consecutive pair of efficiency sections. Each spacer section is one layer of spacer material having a thickness of 0.48 mm. The spacer sections (and, therefore, the spacer material) have a flow resistivity of 11.8 Pa/(cm/s)/cm.

Surprisingly, the introduction of spacer sections between the efficiency sections, as in the example vent assembly tested with respect to FIG. 4, resulted in a higher saturation of oil in each of the efficiency sections compared to efficiency sections lacking spacer sections between them, such as in the example described with reference to the test results depicted in FIG. 3. Each of the efficiency sections of FIG. 4 held at least about 60% of oil by volume, and about 10% to 30% more oil by volume than each efficiency section of the vent assembly described with reference to FIG. 3. Thus, separating efficiency sections with spacer sections increases the oil holding capacity of the efficiency sections.

FIG. 5 shows further comparison data of yet another vent assembly consistent with the technology disclosed herein. More particularly, efficiency sections alternate with spacer sections in a series along the airflow pathway of a vent body consistent with descriptions above. Each of the efficiency sections and spacer sections extend across the airflow pathway. The spacer sections are disposed between each pair of efficiency sections, and each spacer section is identical to the spacer sections described above with reference to FIG. 4. The efficiency sections (and, therefore, each layer of efficiency filter material), however, have a greater flow resistivity, 88.6 Pa/(cm/s)/cm, than that of the efficiency sections described with reference to FIG. 4. Each efficiency section is 4 discrete and identical layers of filter material, each having a thickness of 0.72 mm at 10.34 kPa.

Each of the efficiency sections of FIG. 5 except for one held over 90% oil by volume, and the last efficiency section held about 55% of oil by volume. It is noted that, with respect to the data corresponding to the third and fourth efficiency sections, it is possible that one or both of (1) the efficiency sections expanded and as a result accommodated a higher volume of oil than the unexpanded volume and (2) mathematical errors result in data reflecting the over 100% saturation with oil by volume. Overall, the vent assembly consistent with FIG. 5 held a higher volume of oil compared to the vent assembly consistent with FIG. 4.

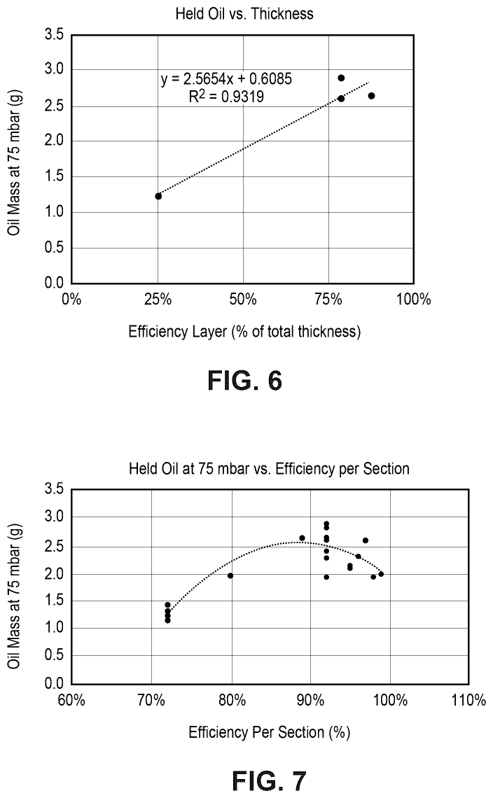

FIG. 6 depicts additional test results comparing the vent assembly consistent with the description of FIG. 5 with other vent assemblies having identical layers of filter material to form each efficiency section, and identical layers of spacer material to form each spacer section. The efficiency sections and the spacer sections alternate in a regular, consistent pattern along the series in each vent assembly. However, in each vent assembly the efficiency sections had a different combined thickness relative to the total series thickness T, which is reflected on the x-axis. The mass of oil held by the plurality of sections of filtration media at a 75-mbar pressure drop across the vent assembly is reflected on the y-axis.

The testing set-up and conditions are consistent with those described above with reference to FIG. 5. The test was conducted until a terminal pressure of 140 mbar at a particular time (Tₜₑᵣₘᵢₙₐₗ), and the mass of oil (Mₜₑᵣₘᵢₙₐₗ) held by the plurality of sections of filtration media at Tₜₑᵣₘᵢₙₐₗ was determined by measuring the difference in mass before loading and after reaching the terminal pressure. Because the supply of aerosol directed through the vent assembly was at a constant rate during testing and the amount of time to reach 75 mbar (T_{75 mbar}) was a known variable recorded by the testing equipment, the mass of oil held by the plurality of sections of filtration media at 75 mbar (M_{75 mbar}) was calculated with the following equation that is depicted in FIG. 6:

$$\frac{{M}_{terminal}}{{T}_{terminal}} \times {T}_{75 mbar} = {M}_{75 mbar}$$

Notably, a relatively high combined thickness of the efficiency sections relative to the total series thickness T resulted in a notable increase in the mass of oil held.

Based on this data, it appears that increasing the percentage of the total thickness of the series thickness T that is defined by the efficiency sections 182 increases the amount of oil that can be collected by the vent assembly 100. However, if the percentage of the total thickness of the series thickness T that is defined by the efficiency sections 182 is too high and, thus, the distance defined between the efficiency sections 182 by the spacer sections 184 is too small, the oil holding capacity of the efficiency sections 182 is expected to decrease to approach the oil holding capacity of a plurality of sections of filtration media lacking spacer sections (such as described with reference to FIG. 3). In various embodiments, the total thickness of the efficiency sections 182 is at least 70% or 75% of the total series thickness T. Generally, the combined thickness of the efficiency sections 182 will be less than 99%, 97% or 95% of the total series thickness T. In some embodiments, the combined thickness of the efficiency sections 182 is from 77% to 90% of the total series thickness T. The thicknesses are measured at 10.34 kPa.

FIG. 7 provides collected data reflecting the total oil loading of the plurality of sections of filtration media of a vent assembly at 75 mbar compared to the particle capture efficiency for 0.4 μm particles per efficiency section. Each of the efficiency sections and spacer sections within each tested vent assembly were identical, but various different efficiency sections and spacer sections were tested across different vent assemblies. The test set-up and conditions are consistent with those described above with reference to FIGS. 3-6. Oil loading at 75 mbar was calculated as described above with reference to FIG. 6. Efficiency sections having at least 80% particle capture efficiency appear to demonstrate relatively higher oil loading compared to efficiency sections having lower particle capture efficiency. Additionally, as the particle capture efficiency increases beyond 93%, the oil loading of the plurality of sections of filtration media may demonstrate a relative decrease.

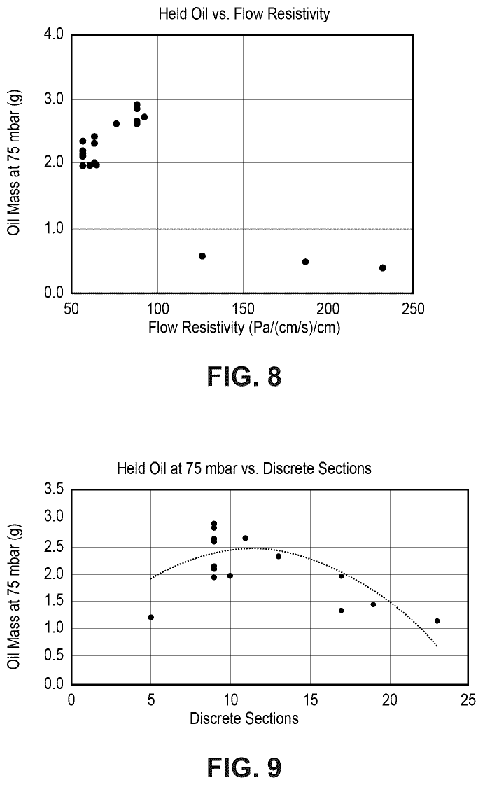

FIG. 8 provides collected data reflecting the total oil loading of the plurality of sections of filtration media of a vent assembly at 75 mbar compared to the flow resistivity efficiency sections. Each of the efficiency sections and spacer sections within each individual tested vent assembly were identical, although various different efficiency sections and spacer sections were tested across different vent assemblies. The test set-up and conditions are consistent with those described above with reference to FIG. 7. Oil loading at 75 mbar was calculated as described above with reference to FIG. 6. Efficiency sections having a flow resistivity greater than 65 Pa/(cm/s)/cm appear to demonstrate relatively higher oil holding capacity compared to efficiency sections having lower flow resistivity. Efficiency sections having a flow resistivity of less than about 125 Pa/(cm/s)/cm appear to demonstrate relatively higher oil holding capacity compared to efficiency sections having higher flow resistivity. In the current testing, flow resistivity of about 89.0 Pa/(cm/s)/cm appeared to maximize the oil holding capacity of the efficiency sections for the particular configurations tested based on the flow resistivities tested.

FIG. 9 provides collected data reflecting the total oil loading of the plurality of sections of filtration media of a vent assembly at 75 mbar compared to the number of discrete efficiency sections. Each of the efficiency sections and spacer sections within each individual tested vent assembly were identical, although various different efficiency sections and spacer sections were tested across different vent assemblies. The test set-up and conditions are consistent with those described above with reference to FIGS. 3-7. The plurality of sections of filtration media in each vent assembly tested had a series thickness of 12.5 mm. Oil loading at 75 mbar was calculated as described above with reference to FIG. 6. This data demonstrates a relative increase in oil loading when there are greater than 5 efficiency sections in the 12.5 mm stack, which equates to greater than 40 efficiency sections per 100 mm of series thickness. There is also a relative increase in oil loading when there are less than 17 efficiency sections in the 12.5 mm stack, which equates to less than 136 efficiency sections per 100 mm of series thickness.

Based on the results of FIG. 9, it may be desirable to have 9 to 13 efficiency sections in a 12.5 mm stack, or 72 to 104 efficiency sections per 100 mm of series thickness. However, it should be noted that these test results are only one example using the same layers of material to form the efficiency sections and the same layers of material to form the spacer sections. Different materials and combinations of materials being used as spacer sections and efficiency sections may result in different number of discrete efficiency sections that achieve relatively higher oil holding.

### Efficiency Sections

Returning to FIGS. 1 and 2, the efficiency sections 182 can be a variety of types of materials and combinations of materials. In various embodiments, one or more of the efficiency sections 182 are a nonwoven filtration media. One or more of the efficiency sections 182 can be constructed of polymeric fibers. One or more of the efficiency sections 182 can be constructed of fibers such as polypropylene, polyethylene, PET, nylon, and cellulose fibers as examples. One or more of the efficiency sections 182 can be constructed with fibers and a binder material, such as binder resin or binder fibers. For example, one or more efficiency sections 182 can have binder fibers such as thermoplastic fibers and/or bicomponent fibers. The bicomponent fibers can be constructed of two different polymers, such as two different polyesters. In some embodiments, one or more efficiency sections 182 can have glass fibers. In at least some embodiments the glass fibers are microfibers. Generally, one or more efficiency sections 182 substantially lacks a binder material, where the term “binder material” is defined herein to exclude fibers such as binder fibers, bicomponent fibers, or other fibers. In a variety of embodiments, one or more efficiency sections 182 of the vent assembly 100 contains oil coalescing filter media. In some embodiments, at least one of the plurality of efficiency sections 182 includes an adsorbent material.

One or more efficiency sections 182 in the plurality of sections of filtration media 180 of the vent assembly 100 can be a plurality of layers of filter media arranged in a series. In some embodiments one or more layers of the filter media are constructed of synthetic fibers. A substantial portion of the layers can be arranged such that each flow face of each layer of filter media is in direct contact with the flow faces of adjacent layers of filter media, and each flow face extends across the airflow pathway 150. The term “flow face” is used to mean each surface of the filter media that is configured to face the directions of airflow through the airflow pathway 150. In various embodiments, the airflow pathway 150 extends in an axial direction and each layer of filter media is perpendicular to the axial direction, although such a configuration is not necessarily limited. In some other embodiments, one or more efficiency sections 182 is a mass of fibers. Furthermore, each efficiency section need not be identical.

In a variety of embodiments the efficiency of each efficiency section 182 and the total number of efficiency sections 182 is configured to achieve the target overall particle capture efficiency of the plurality of sections of filtration media 180.

### Spacer Sections

The spacer sections 184 can be a variety of types of materials and combinations of materials. In some embodiments, one or more of the spacer sections 184 are constructed of a fibrous material. The fibrous material can be non-woven or woven. The fibers can include polymeric fibers and non-polymeric fibers. One or more of the spacer sections 184 can have a binder material, such as a binder resin or binder fibers. For example, one or more spacer sections 184 can have bicomponent fibers. The bicomponent fibers can be constructed of two different polymers, such as two different polyesters. In some embodiments, one or more spacer sections 184 can have glass fibers, such as glass microfibers. In a variety of embodiments, one or more spacer sections 184 of the vent assembly 100 contains coalescing filter media. In some embodiments, one or more spacer sections 184 has cellulose fibers. In some examples, one or more spacer sections 184 substantially lacks a binder material. In some embodiments one or more spacer sections 184 does have a binder material distributed among the fibers, such as a binder resin. In some embodiments, at least one of the plurality of spacer sections 184 includes an adsorbent. In some other embodiments, an adsorbent layer is disposed across the airflow pathway 150 between the membrane 160 and the plurality of sections of filtration media 180. In some examples the spacer layer will be made from metal fibers. In other embodiments the fibers will be woven into a patterned structure.

It is noted that the spacer sections 184 need not be a filtration material or a fibrous media. In some embodiments one or more spacer sections 184 is a lattice or screen structure constructed of metal or polymeric material. In some embodiments one or more spacer sections 184 includes a scrim material. In some embodiments one or more of the spacer sections 184 do not exhibit a particle capture efficiency with respect to oil aerosols. In some such embodiments, one or more of the spacer sections 184 may capture relatively large particles, however.

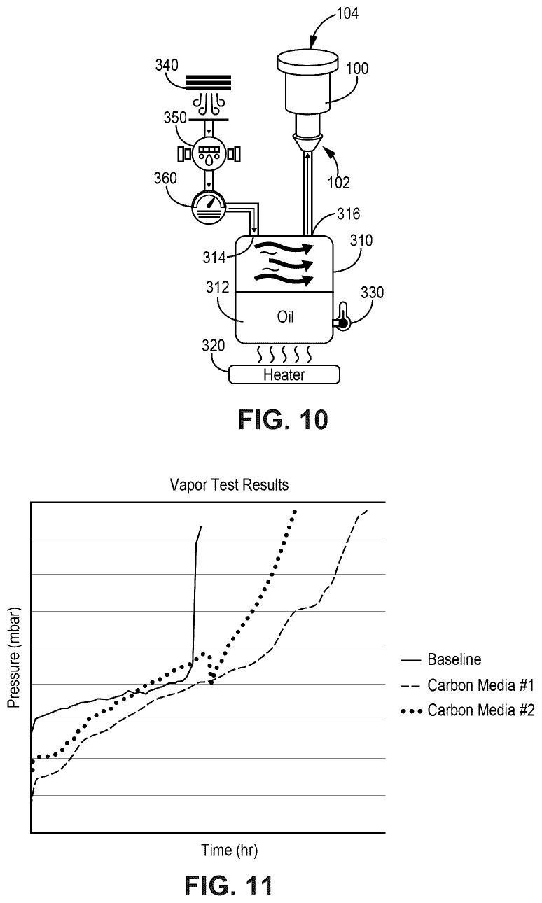

It has been discovered that using an adsorbent material as a spacer layer may advantageously improve the life of the vent assembly in implementations where the vented enclosure is heated and oil vapor is generated within the enclosure. FIG. 10 is a schematic test set-up used to test a number of different configurations of the plurality of sections of filtration media. An enclosure 310 contains a volume of oil 312, and a heating element 320 heats the oil and maintains the oil at a constant temperature, which is monitored by a temperate sensor 330. A flow meter 350 directs a constant flow rate of air from an air supply 340 into an inlet 314 of the enclosure 310 and generates airflow across the oil 312 to create an airflow stream containing oil vapor. A vent assembly 100 is coupled to an outlet 316 of the enclosure 310 and the vapor-containing airflow passes into the first end 102 of the vent assembly 100, through the plurality of sections of filtration media and the membrane, and vents to the outside environment through the second end 104 of the vent assembly 100. The pressure differential was measured across the vent assembly 100 with a pressure sensor 360 at constant intervals until a terminal pressure differential was achieved.

The test results are depicted in FIG. 11. Each of the vent assemblies tested has an identical vent housing, and an identical membrane disposed across the vent housing. The Baseline vent assembly does not have spacer sections within the plurality of sections of filtration media and is a series of identical layers of filtration media (referred to as “baseline filtration media”) having a total thickness sufficient to fill the available volume of the vent housing. The plurality of sections of filtration media has a flow resistivity of 57.0 Pa/(cm/s)/cm. The plurality of sections of filtration media has an overall particle capture efficiency of greater than 97%. Carbon Media #1 vent assembly has a plurality of sections of the filtration media that included efficiency sections and spacer sections. Each efficiency section is 4 discrete and identical layers of baseline filtration media. A spacer section is disposed between each consecutive pair of efficiency sections in the series. Each spacer section is a single layer of an adsorbent carbon filtration material having a carbon media layer with a scrim layer laminated to each side. The spacer section has a nominal Frazier permeability of 245 ft³/min/ft² and a flow resistivity of 6.1 Pa/(cm/s)/cm. The plurality of sections of filtration media has an overall particle capture efficiency of greater than 97% and a total thickness sufficient to fill the available volume of the vent housing.

The Carbon Media #2 vent assembly has a plurality of sections of the filtration media that included efficiency sections and spacer sections. Each efficiency section is 4 discrete and identical layers of baseline filtration media. A spacer section is disposed between each consecutive pair of efficiency sections in the series. Each spacer section is a single layer of an adsorbent carbon filtration material. Each spacer section has a nominal Frazier air permeability of 1699 L/m² sec (209 ft³/min/ft²) and a flow resistivity of 8.4 Pa/(cm/s)/cm. The plurality of sections of filtration media have an overall particle capture efficiency of greater than 97% and a total thickness at sufficient to fill the available volume of the vent housing.

As is visible in FIG. 11, the Carbon Media #1 and Carbon Media #2 vent assemblies took longer to reach the terminal pressure drop than the Baseline vent assembly by at least two hours. These performance differences correlate to the Carbon Media vent assemblies having a relatively longer useful life than the Baseline vent assembly in implementations where the vent assembly is exposed to oil vapor.

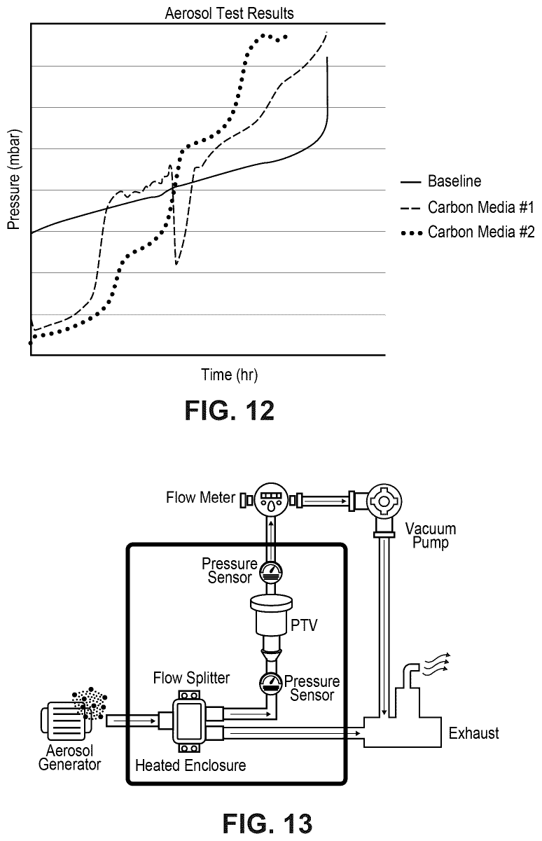

FIG. 12 reflects test results comparing the example vent assemblies described above with reference to FIGS. 10-11 when each vent assembly was challenged with a constant flow rate of oil aerosol over time and the pressure differential across the vent assembly over time was recorded until a terminal pressure differential was reached. The schematic test set-up depicted in FIG. 13 is representative of the testing now described. Each of the carbon media vent assemblies achieved a terminal pressure within 20% of the time it took for the Baseline vent assembly to reach terminal pressure, correlating with a similar useful life in implementations where the vent assembly is exposed to oil aerosols.

It is noted that, while various test results disclosed herein utilized efficiency sections that were identical and spacer sections that were identical, this was only to help isolate the variables that may impact performance of the vent assembly. Depending on the specific implementation, it may be desirable to incorporate one or more efficiency sections that have different material properties, such as air permeability, particle capture efficiency, flow resistivity and thickness (as examples), than one or more other efficiency sections. Similarly, one or more spacer sections may have different material properties than one or more other spacer sections. Furthermore, it may be desirable to incorporate an intervening section within the plurality of sections of filtration media that is not an efficiency section or a spacer section.

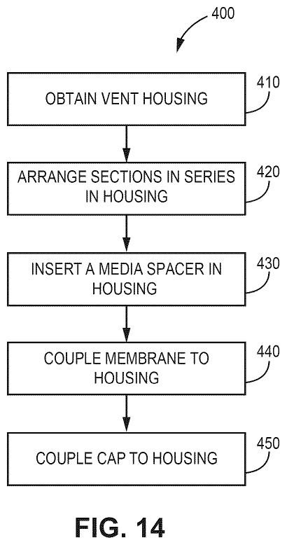

FIG. 14 is a flow chart depicting one method consistent with the technology disclosed herein. The method 400 is generally consistent with making a vent assembly.

A vent housing is obtained 410. Sections of filtration material are arranged in a series in the housing 420. A media spacer is inserted in the housing 430. A membrane is coupled to the housing 440. A cap is coupled to the housing 450.

Obtaining the vent housing 410 may include forming the vent housing. The vent housing is generally formed to have a first end and a second end, and to define an airflow pathway extending from the first end to the second end. The vent housing can be formed 410 consistently with approaches that will generally be understood in the art. In one embodiment, the vent housing is formed 410 through an injection molding process. In another embodiment, the vent housing is formed 410 through blow molding. The vent housing can be formed 410 from a variety of materials and combinations of materials that have been discussed above.

When arranging the sections of filtration media in the housing 420, the plurality of sections of filtration media are generally arranged within the airflow pathway. Efficiency sections and spacer sections are position in the housing to alternate along the airflow pathway. The material construction and properties of the efficiency sections and spacer sections have been described in detail above. In some embodiments, arranging the plurality sections of filtration media in the airflow pathway of the housing can be executed such that some of the sections of filtration media are non-aligned with some other of the sections of filtration media. Non-alignment of at least a portion of the plurality of sections of filtration media may have the advantage of preventing air within the vent assembly from bypassing the filtration media.

Inserting a media spacer in the housing 430 can aid in containing the plurality of sections of filtration media in the housing. In embodiments, the media spacer and the vent housing mutually define an interference fit such that inserting the media spacer in the housing 430 causes a coupling structure defined by the media spacer to engage a mating structure defined by the vent housing. In an alternate embodiment, the media spacer may be bonded to the vent housing, such as by a thermal weld or adhesive.

The membrane is generally coupled to the vent housing 440 in a spaced relationship from the plurality of sections of filtration media. In a variety of embodiments the membrane is coupled to a membrane receiving surface 440 defined by the vent housing. In one embodiment, the membrane is coupled to the vent housing 440 with an adhesive. In another embodiment, the membrane is coupled to the vent housing 440 by a weld, such as a thermal weld or ultrasonic weld. It is noted that, in some embodiments, no membrane is used in the vent assembly. In such embodiments a membrane is not coupled to the housing 440.

In a variety of embodiments, the method of making a vent assembly can have the additional step of coupling a cap to the housing 450 to shield a flow face of the membrane or a flow face of the plurality of layers of filtration media (where a membrane is omitted), from the environment.

### Exemplary Aspects

Aspect 1. A vent assembly comprising:
a vent housing having a first end and a second end, wherein the vent housing defines a mounting structure and an airflow pathway extending from the mounting structure to the environment external to the vent housing; and
a plurality of sections of filtration media arranged in a series along the airflow pathway, wherein the plurality of sections are disposed across the airflow pathway, wherein the plurality of sections of filtration media comprises efficiency sections and spacer sections alternating with the efficiency sections within the series, and wherein each spacer section has a flow resistivity up to 80% of a flow resistivity of each efficiency section.

Aspect 2. The vent assembly of any one of Aspects 1 and 3-14, wherein the plurality of sections comprises at least five sections.

Aspect 3. The vent assembly of any one of Aspects 1-2 and 4-14, wherein the vent assembly comprises at least 7 sections per 100 mm of series thickness.

Aspect 4. The vent assembly of any one of Aspects 1-3 and 5-14, wherein each efficiency section has a flow resistivity from 25.5 Pa/(cm/s)/cm to 125 Pa/(cm/s)/cm.

Aspect 5. The vent assembly of any one of Aspects 1-4 and 6-14, wherein each spacer section has a flow resistivity up to 23.6 Pa/(cm/s)/cm.

Aspect 6. The vent assembly of any one of Aspects 1-5 and 7-14, wherein the efficiency sections have a combined thickness of 70%-95% of the total thickness of the series at 10.34 kPa.

Aspect 7. The vent assembly of any one of Aspects 1-6 and 8-14, wherein the series has an overall particle capture efficiency of at least 97%.

Aspect 8. The vent assembly of any one of Aspects 1-7 and 9-14, wherein each efficiency section has a particle capture efficiency of greater than 75%.

Aspect 9. The vent assembly of any one of Aspects 1-8 and 10-14, wherein each section has a density from 0.10 to 0.4 g/cm³ at 10.34 kPa.

Aspect 10. The vent assembly of any one of Aspects 1-9 and 11-14, wherein the plurality of sections comprises binder fibers and glass fibers.

Aspect 11. The vent assembly of any one of Aspects 1-10 and 12-14, further comprising a membrane disposed in the vent housing across the airflow pathway between the plurality of sections and the external environment.

Aspect 12. The vent assembly of any one of Aspects 1-11 and 13-14, further comprising an adsorbent layer disposed across the airflow pathway between the membrane and the plurality of sections.

Aspect 13. The vent assembly of any one of Aspects 1-12 and 14, wherein at least one spacer layer comprises an adsorbent.

Aspect 14. The vent assembly of any one of Aspects 1-13, wherein each spacer section has a Frazier air permeability of at least 200 ft³/min/ft².

Aspect 15. A vent assembly comprising:
a vent housing having a first end and a second end, wherein the vent housing defines a mounting structure and an airflow pathway extending from the mounting structure to the environment external to the vent housing; and
a plurality of sections of filtration media arranged in a series along the airflow pathway, wherein the plurality of sections are disposed across the airflow pathway, wherein the plurality of sections of filtration media comprises efficiency sections and spacer sections alternating with the efficiency sections within the series, wherein the series has an overall particle capture efficiency of at least 97%, and wherein each efficiency section has a particle capture efficiency of at least 80%.

Aspect 16. The vent assembly of any one of Aspects 15 and 17-28, wherein the plurality of sections comprises at least five sections.

Aspect 17. The vent assembly of any one of Aspects 15-16 and 18-28, wherein the vent assembly comprises at least 7 sections per 100 mm of series thickness.

Aspect 18. The vent assembly of any one of Aspects 15-17 and 19-28, wherein each efficiency section has a flow resistivity from 25.5 Pa/(cm/s)/cm to 125 Pa/(cm/s)/cm.

Aspect 19. The vent assembly of any one of Aspects 15-18 and 20-28, wherein each spacer section has a flow resistivity up to 23.6 Pa/(cm/s)/cm.

Aspect 20. The vent assembly of any one of Aspects 15-19 and 21-28, wherein the efficiency sections have a combined thickness of 70%-95% of the total thickness of the series at 10.34 kPa.

Aspect 21. The vent assembly of any one of Aspects 15-20 and 22-28, wherein each spacer section has a flow resistivity up to 80% of a flow resistivity of each efficiency section.

Aspect 22. The vent assembly of any one of Aspects 15-21 and 23-28, wherein each efficiency section has a particle capture efficiency of at least 85%.

Aspect 23. The vent assembly of any one of Aspects 15-22 and 24-28, wherein each section has a density from 0.10 to 0.4 g/cm³ at 10.34 kPa.

Aspect 24. The vent assembly of any one of Aspects 15-23 and 25-28, wherein the plurality of sections comprises binder fibers and glass fibers.

Aspect 25. The vent assembly of any one of Aspects 15-24 and 26-28, further comprising a membrane disposed in the vent housing across the airflow pathway between the plurality of sections and the external environment.

Aspect 26. The vent assembly of any one of Aspects 15-25 and 27-28, further comprising an adsorbent layer disposed across the airflow pathway between the membrane and the plurality of sections.

Aspect 27. The vent assembly of any one of Aspects 15-26 and 28, wherein at least one spacer layer comprises an adsorbent.

Aspect 28. The vent assembly of any one of Aspects 15-27, wherein each spacer section has a Frazier air permeability of at least 200 ft³/min/ft².

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

The term “about” as used herein can allow for a degree of variability in a value or range, for example, within 10%, within 5%, or within 1% of a stated value or of a stated limit of a range and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A vent assembly comprising:
a vent housing having a first end and a second end, wherein the vent housing defines a mounting structure and an airflow pathway extending from the mounting structure to the environment external to the vent housing; and
a plurality of sections of filtration media arranged in a series along the airflow pathway, wherein the plurality of sections are disposed across the airflow pathway, wherein the plurality of sections of filtration media comprises efficiency sections and spacer sections alternating with the efficiency sections within the series, and wherein each spacer section has a flow resistivity up to 80% of a flow resistivity of each efficiency section.

2. The vent assembly of claim 1, wherein the plurality of sections comprises at least five sections.

3. The vent assembly of claim 1, wherein the vent assembly comprises at least 7 sections per 100 mm of series thickness.

4. The vent assembly of claim 1, wherein each efficiency section has a flow resistivity from 25.5 Pa/(cm/s)/cm to 125 Pa/(cm/s)/cm.

5. The vent assembly of claim 1, wherein each spacer section has a flow resistivity up to 23.6 Pa/(cm/s)/cm.

6. The vent assembly of claim 1, wherein the efficiency sections have a combined thickness of 70%-95% of the total thickness of the series at 10.34 kPa.

7. The vent assembly of claim 1, wherein each efficiency section has a particle capture efficiency of greater than 75%.

8. The vent assembly of claim 1, wherein each section has a density from 0.10 to 0.4 g/cm³ at 10.34 kPa.

9. The vent assembly of claim 1, further comprising a membrane disposed in the vent housing across the airflow pathway between the plurality of sections and the external environment.

10. The vent assembly of claim 1, wherein at least one spacer layer comprises an adsorbent.

11. A vent assembly comprising:
a vent housing having a first end and a second end, wherein the vent housing defines a mounting structure and an airflow pathway extending from the mounting structure to the environment external to the vent housing; and
a plurality of sections of filtration media arranged in a series along the airflow pathway, wherein the plurality of sections are disposed across the airflow pathway, wherein the plurality of sections of filtration media comprises efficiency sections and spacer sections alternating with the efficiency sections within the series, wherein the series has an overall particle capture efficiency of at least 97%, and wherein each efficiency section has a particle capture efficiency of at least 80%.

12. The vent assembly of claim 11, wherein the plurality of sections comprises at least five sections.

13. The vent assembly of claim 11, wherein the vent assembly comprises at least 7 sections per 100 mm of series thickness.

14. The vent assembly of claim 11, wherein each efficiency section has a flow resistivity from 25.5 Pa/(cm/s)/cm to 125 Pa/(cm/s)/cm.

15. The vent assembly of claim 11, wherein each spacer section has a flow resistivity up to 23.6 Pa/(cm/s)/cm.

16. The vent assembly of claim 11, wherein the efficiency sections have a combined thickness of 70%-95% of the total thickness of the series at 10.34 kPa.

17. The vent assembly of claim 11, wherein each spacer section has a flow resistivity up to 80% of a flow resistivity of each efficiency section.

18. The vent assembly of claim 11, wherein each section has a density from 0.10 to 0.4 g/cm³ at 10.34 kPa.

19. The vent assembly of claim 11, wherein the plurality of sections comprises binder fibers and glass fibers.

20. The vent assembly of claim 11, wherein each spacer section has a Frazier air permeability of at least 200 ft³/min/ft².
